(19) United States
(12) Patent Application Publication
(10) Pub. No.: US 2008/0024610 A1
(43) Pub. Date: Jan. 31, 2008

(54) Monitoring Apparatus, Monitoring System, Monitoring Method and Program

(76) Inventor: Tetsuya KONISHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/780,962

(22) Filed: Jul. 20, 2007

(30) Foreign Application Priority Data
Jul. 27, 2006 (JP) P2006-205067

(51) Int. Cl. H04N 5/445

(52) U.S. Cl. 348/159; 348/E05.053

(57) ABSTRACT

A monitoring apparatus using video data imaged and outputted from a monitoring imaging device for monitoring, the apparatus includes: a filter setting part configured to store filter information for analyzing the video data; a vanishing point setting part configured to store a place in which an object included in the video data can disappear out of an area for a monitoring target of the monitoring imaging device as an area having a vanishing point; and a filtering part configured to use filter information for analyzing the video data and to generate alarm information in accordance with the analyzed result, wherein in the case in which it is recognized that an object has once disappeared in the area having the vanishing point and an object is again detected at almost the same place, the filtering part recognizes that two objects are different objects and analyzes the video data.

### CROSS REFERENCES TO RELATED APPLICATIONS

The present invention contains subject matter related to Japanese Patent Application JP 2006-205067 filed in the Japanese Patent Office on Jul. 27, 2006, the entire contents of which being incorporated herein by reference.

### BACKGROUND OF THE INVENTION

1. Field of the Invention

The present invention relates to a monitoring apparatus, a monitoring system and a monitoring method, which acquire video data and data (metadata) related to video data from a monitoring camera to filter the metadata and output the monitoring result based on the filtered result obtained from the filtering process, and a program which executes the monitoring method.

2. Description of the Related Art

Heretofore, a monitoring system is used which connects a monitoring camera to a control unit via a network. In such a monitoring system, a monitoring camera sends taken video data to a monitoring apparatus that is a control unit via a network. The monitoring apparatus records the received video data as well as analyzes the video data to detect the occurrence of irregularities, and outputs alarms. A monitoring person can monitor while he/she is confirming monitor video displayed on a monitor and the descriptions of the alarms outputted from the control unit.

In addition, the recent monitoring cameras not only send taken video data to the monitoring apparatus but also have a function that generates metadata about taken video data (for example, alarm information, temperature information, and field angle information about the camera) and send metadata to the monitoring apparatus. In the monitoring system using the monitoring camera like this, the monitoring apparatus filters metadata supplied from the monitoring camera through a metadata filter in which certain conditions are set to output alarms (hereinafter, referred to as a filter), and outputs alarms when the conditions are matched. For example, such conditions are set to the metadata filter that detect irregularities such as a trespasser into a certain place and a moving object (an object) passing through a certain border line.

Patent Reference 1 describes a technique in which video data that is monitor video is supplied from a monitoring camera to a monitoring apparatus via a network, and the monitoring apparatus confirms monitor video at the time when the irregularities have occurred (see JP-A-2003-274390).

### SUMMARY OF THE INVENTION

When monitoring is conducted using this type of monitoring system, a matter (moving matter) once recognized as an object may sometimes disappear temporarily and then appear again because of disturbance such as noise on the system and abrupt changes in the brightness and a quick motion of the matter. In this case, in the case in which the matter before disappearing and the matter that appears again are recognized as different objects, the number of the matters recognized as the objects is twice as much as the actual number of the matters. In order to prevent this defect, the setting of the system may sometimes be so configured that the matter once disappeared and appeared again at almost the same place is regarded as the same object.

However, when such a setting is applied at a place where some matters can actually disappear or appear such as an entrance, it may cause another error that different matters are recognized as the same object.

Thus, it is desirable to improve the accuracy of object recognition in a monitoring system.

In an embodiment of the invention, in the case in which video data imaged and outputted from a monitoring imaging device is used for monitoring, information about video of a monitoring target is generated from imaged data. Then, filter information for analysis is stored, and a place at which an object included in information about video of a monitoring target can disappear out of a monitoring target area of the monitoring imaging device is stored as an area having a vanishing point. Then, analysis is made to generate alarm information in accordance with the analyzed result, and in the case in which it is recognized that an object has once disappeared in the area having the vanishing point and an object is again detected at almost the same place, it is recognized that two objects are different objects for analysis.

With this configuration, in the case in which a plurality of objects has disappeared or they have been again confirmed at the place at which an object can disappear out of the monitoring target area of the monitoring imaging device, such an event can be eliminated that the individual objects are considered to be the same object wrong.

According to an embodiment of the invention, in the case in which a plurality of objects have disappeared or they have been again confirmed at the place at which an object can disappear out of the monitoring target area of the monitoring imaging device, since it is recognized that the individual objects are different object, the number of objects computed through such a filter that counts the number of objects satisfying a predetermined condition is more approximated to a true value.

### BRIEF DESCRIPTION OF THE DRAWINGS

FIGS. 1A and 1B show diagrams illustrating an exemplary configuration of a monitoring system according to an embodiment of the invention;

FIG. 2 shows a block diagram depicting an exemplary internal configuration of a monitoring camera according to an embodiment of the invention;

FIG. 3 shows a block diagram depicting an exemplary internal configuration of a client terminal according to an embodiment of the invention;

FIG. 4 shows an illustration depicting an exemplary display of video data and metadata according to an embodiment of the invention;

FIG. 5 shows an illustration depicting an exemplary monitor image according to an embodiment of the invention;

FIG. 6 shows a flow chart depicting an exemplary object recognition process according to an embodiment of the invention; and

FIGS. 7A to 7C show an illustration depicting an exemplary monitor image according to an embodiment of the invention.

### DETAILED DESCRIPTION OF THE INVENTION

Hereinafter, the best mode for implementing an embodiment of the invention will be described with reference to the drawings. An embodiment described below is an example suited for a monitoring system in which an imaging device (a monitoring camera) takes video data of a shooting target and generates metadata, and the obtained metadata is analyzed to detect a moving object (an object) to output the detected result.

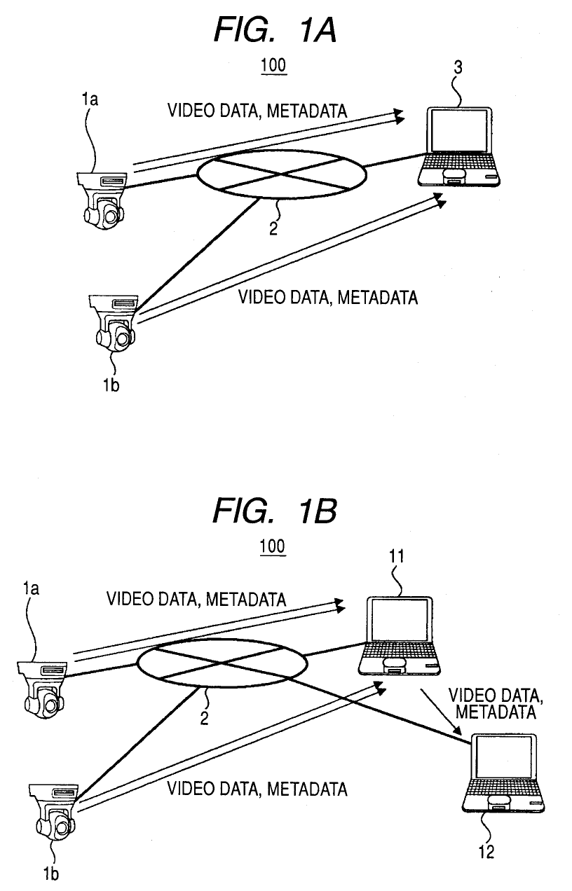

FIGS. 1A and 1B are a diagram depicting the configuration of connections in an exemplary monitoring system according to an embodiment of the invention.

FIG. 1A shows a system in which a client terminal as a monitoring apparatus acquires data outputted from a monitoring camera via a network, and FIG. 1B shows a system in which a server acquires data outputted from the monitoring camera, and supplies it to the client terminal (a server/client system) First, a monitoring system 100 shown in FIG. 1A will be described. As shown in FIGS. 1A and 1B, the monitoring system 100 manages a single or a plurality of monitoring cameras. In this example, two cameras are managed. The monitoring system 100 is configured of monitoring cameras 1a and 1b which shoot a monitoring target and generate video data as well as generate metadata from video data, a client terminal 3 which stores the acquired video data and metadata, analyzes the metadata, and outputs the result, and a network 2 which connects the monitoring cameras 1a and 1b to the client terminal 13. The metadata acquired by the client terminal 3 from the monitoring cameras 1a and lb via the network 2 is analyzed through a metadata filter (hereinafter, also referred to as a “filter”). In order to control the operations of the monitoring cameras 1a and 1b so as to obtain monitor video suited for monitoring depending on the descriptions of the filtered result, the client terminal 3 supplies switching instruction signals to the monitoring cameras 1a and 1b.

In addition, naturally, the numbers of the monitoring camera, the client terminal, the server and the client terminal are not restricted to this embodiment.

Here, metadata generated in the monitoring camera will be described. The term metadata is attribute information of video data taken by the imaging part of the monitoring camera. For example, the following is named.
a) Object information (information about an ID, coordinates, and the size of a moving object (an object) when the moving object is detected by the monitoring camera).
b) Shooting time data, and orientation information of the monitoring camera (a pan tilt, for example).
c) Position information of the monitoring camera.
d) Signature information of the taken image.

The term object information is information that information described as binary data in metadata is extended to a data structure with meanings such as a structure.

The term metadata filter is decision conditions when alarm information is generated from object information, and the term alarm information is information that is filtered based on the object information extended from metadata. The term alarm information is in formation that is obtained by analyzing a plurality of frames of metadata to determine the velocity from the changes in the position of a moving object, by confirming whether a moving object crosses over a certain line, or by analyzing them in a composite manner.

For example, for the types of filters, there are seven types below, and a given type of filter among them may be used.
Appearance: a filter that determines whether an object exists (hereinafter, also referred to as an object) in a certain area.
Disappearance: a filter that determines whether an object appears in a certain area and goes out of the area.
Passing: a filter that determines whether an object crosses over a certain border line.
Capacity (limitation of the number of objects): a filter that counts the number of objects in a certain area and determines whether the accumulated number exceeds a predetermined value.
Loitering: a filter that determines whether an object resides in a certain area over a predetermined time period.
Unattended: a filter that determines whether there is an object entering a certain area and remaining still over a predetermined time period.
Removed: a filter that detects that the object in a certain area has been removed.

For data included in alarm information, there is the filter “Capacity” among the filters described above, for example, including “the accumulated number of objects” that is generated through the filter using the accumulating total value of the detected object, “the number of objects” that is the number of objects matched with the conditions of the filter, the number of objects that is matched with the conditions of the filter within a specific frame, and attribute information of an object matched with the conditions of the filter (the ID, X-coordinate, Y-coordinate and size of an object). As described above, alarm information includes the number (the number of people) in video and statistics thereof, which may be used as a report function.

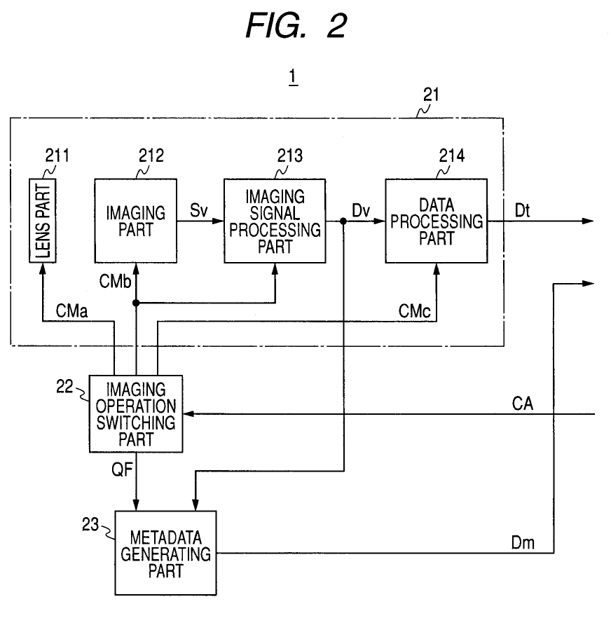

Next, the detailed configuration of the monitoring camera 1 shown in FIG. 1A will be described with reference to a functional block diagram shown in FIG. 2. The monitoring camera 1 is configured of a video data generating part 21, an imaging operation switching part 22, and a metadata generating part 23. First, the individual parts configuring the video data generating part 21 will be described. An imaging part 212 applies photoelectric conversion to imaging lights formed on an imaging element (not shown) formed through a lens part 211, and forms an imaging signal Sv.

The imaging part 212 has a preamplifier part and an A/D (Analog/Digital) converting part, not shown, for example. The preamplifier part amplifies the electric signal level of the imaging signal Sv and removes reset noise caused by correlated double sampling, and the A/D converting part converts the imaging signal Sv from the analog signal into the digital signal. Moreover, the imaging part 212 adjusts the gain of the supplied imaging signal Sv, stabilizes the black level, and adjusts the dynamic range. The imaging signal Sv subjected to various processes is supplied to an imaging signal processing part 213.

The imaging signal processing part 213 performs various signal processes for the imaging signal Sv supplied from the imaging part 212, and generates video data Dv. For example, such processes are performed: knee correction that compresses a certain level or more of the imaging signal Sv, γ correction that corrects the level of the imaging signal Sv in accordance with a set γ curve, white clipping or black clipping that limits the signal level of the imaging signal Sv to a predetermined range, and so on. Then, video data Dv is supplied to data processing part 214.

In order to reduce the data volume in communications with the client terminal 3, for example, the data processing part 214 performs coding process for video data Dv, and generates video data Dt. Furthermore, the data processing part 214 forms the generated video data Dv into a predetermined data structure, and supplies it to the client terminal 3.

Based on a switching instruction signal CA inputted from the client terminal 3, the imaging operation switching part 22 switches the operation of the monitoring camera 1 so as to obtain the optimum imaged video. For example, the imaging operation switching part 22 switches the imaging direction of the imaging part, and in addition to this, it allows the individual parts to do such processes in which a control signal CMa is supplied to the lens part 211 to switch the zoom ratio and the iris, a control signal CMb is supplied to the imaging part 212 and the imaging signal processing part 213 to switch the frame rate of imaged video, and a control signal CMc is supplied the data processing part 214 to switch the compression rate of video data.

The metadata generating part 23 generates metadata Dm that shows information about a monitoring target. In the case in which the moving object is set to a monitoring target, the metadata generating part uses video data Dv generated in the video data generating part 21, detects the moving object, generates moving object detection information indicating whether the moving object is detected, and moving object position information that indicates the position of the detected moving object, and includes them as object information into metadata. At this time, a unique ID is assigned to each of detected objects.

In addition, information about the monitoring target is not restricted to information about the moving object, which may be information indicating the state of the area to be monitored by the monitoring camera. For example, it may be information about the temperature or intensity of the area to be monitored. Alternatively, it may be information about operations done in the area to be monitored. In the case in which the temperature is a monitoring target, the temperature measured result may be included into metadata, whereas in the case in which the intensity is a monitoring target, the metadata generating part 23 may determine the average brightness of monitor video, for example, based on video data Dv, and includes the determined result into metadata.

Furthermore, in the case in which operations done by users on an ATM (Automated Teller Machine) and a POS (Point Of Sales) terminal are monitoring targets, it is sufficient that user operations performed through an operation key and an operation panel are included into metadata.

Moreover, the metadata generating part 23 includes imaging operation QF supplied from the imaging operation switching part 22 (for example, the imaging direction or the zoom state at the time when the monitoring target is imaged, and setting information of the video data generating part) and time information into metadata, whereby the time when metadata is generated and the situations can be left as records.

Here, the configurations of video data and metadata will be described. Video data and metadata are each configured of a data main body and link information. In the case of video data, the data main body is video data that is monitor video taken by the monitoring cameras 1a and 1b. In addition, in the case of metadata, it describes attribute information that defines the description mode of information such as information indicating a monitoring target. On the other hand, the term link information is association information that indicates association between video data and metadata, and information that describes attribute information defining the description mode of the descriptions of information.

For association information, for example, a time stamp that identifies video data and sequence numbers are used. The term time stamp is information that gives a point in time of generating video data (time information), and the term sequence number is information that gives the order of generating contents data (order information). In the case in which there is a plurality of pieces of monitor video having the same time stamp, the order of generating video data having the same time stamp can be identified. Moreover, for association information, such information may be used that identifies a device to generate video data (for example, manufacturer names, product type names, production numbers and so on).

In order to describe link information about a metadata main body, the Markup Language is used that is defined by describing information exchanged on the web (WWW: World Wide Web). With the use of the Markup Language, information can be easily exchanged via the network 2. Furthermore, for the Markup Language, for example, with the use of XML (Extensible Markup Language) that is used to exchange documents and electric data, video data and metadata can be easily exchanged. In the case of using XML, for the attribute information that defines the description mode of information, for example, the XML schema is used.

Video data and metadata generated by the monitoring cameras 1a and 1b may be supplied as a single stream to the client terminal 3, or video data and metadata may be supplied asynchronously to the client terminal 3 in separate streams.

In addition, as shown in FIG. 1B, even though the server function and the client function are separated from each other and applied to the monitoring system configured of the server 11 and the client terminal 12, the same function and advantages as those of the example shown in FIG. 1A described above can be obtained. The server function and the client function are separated from each other, whereby such separate use may be possible that large amount of data is processed in the server 11 with high processing performance, whereas only the processed result is browsed in the client terminal 12 with low processing performance. As described above, the functions are distributed to exert the advantage that can construct the monitoring system 100 with increased flexibility.

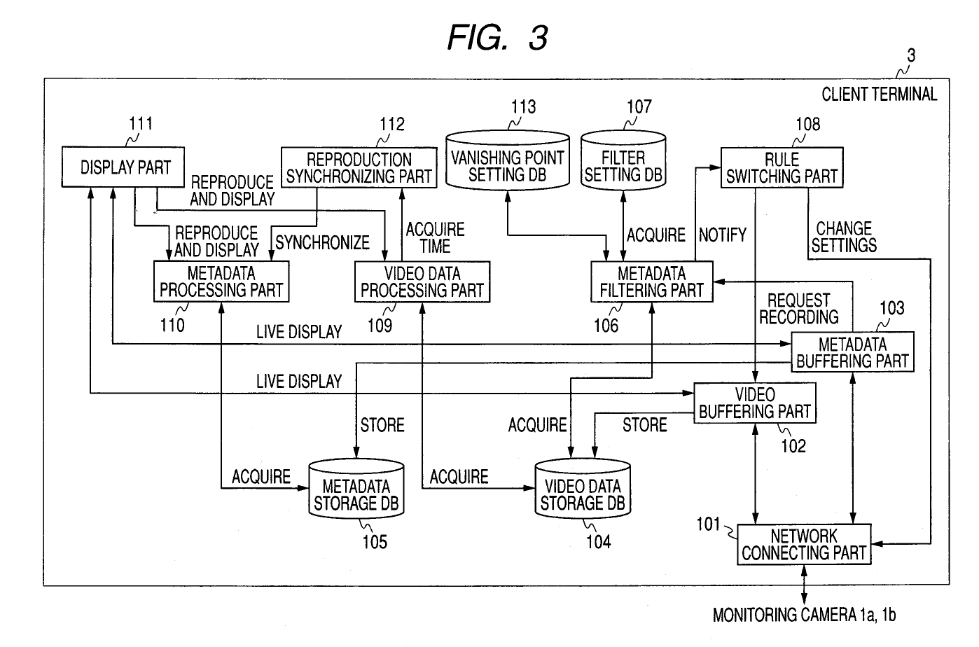

Next, the detailed configuration of the client terminal 3 shown in FIG. 1A will be described with reference to a functional block diagram shown in FIG. 3. However, the functional blocks of the client terminal 3 may be configured of hardware, or may be configured of software.

The client terminal 3 has a network connecting part 101 which transmits data with the monitoring cameras 1a and 1b, a video buffering part 102 which acquires video data from the monitoring cameras 1a and 1b, a metadata buffering part 103 which acquires metadata from the monitoring cameras 1a and 1b, a filter setting database 107 which stores filter settings in accordance with the filtering process, a metadata filtering part 106 as a filtering part which filters metadata, a vanishing point setting database 113 which stores vanishing point setting information when a location at which an object can disappear out of the monitoring target area of the monitoring camera is set as “an area having a vanishing point”, a rule switching part 108 which notifies a change of settings to the monitoring cameras 1a and 1b, a video data storage database 104 which stores video data, a metadata storage database 105 which stores metadata, a display part 111 which displays video data and metadata, a video data processing part 109 which performs processes to reproduce video data on the display part 111, a metadata processing part 110 which performs processes to reproduce metadata on the display part 111, and a reproduction synchronizing part 112 which synchronizes the reproduction of metadata with video data.

The video buffering part 102 acquires video data from the monitoring cameras 1a and 1b, and decodes coded video data. Then, the video buffering part 102 holds obtained video data in a buffer, not shown, disposed in the video buffering part 102. Furthermore, the video buffering part 102 also in turn supplies video data held in the buffer, not shown, to the display part 111 which displays images thereon. As described above, video data is held in the buffer, not shown, whereby video data can be in turn supplied to the display part 111 without relying on the reception timing of video data from the monitoring cameras 1a and 1b. Moreover, the video buffering part 102 stores the held video data in the video data storage database 104 based on a recording request signal supplied from the rule switching part 108, described later. In addition, this scheme may be performed in which coded video data is stored in the video data storage database 104, and is decoded in the video data processing part 109, described later.

The metadata buffering part 103 holds metadata acquired from the monitoring cameras 1a and 1b in the buffer, not shown, disposed in the metadata buffering part 103. Moreover, the metadata buffering part 103 in turn supplies the held metadata to the display part 111. In addition, it also supplies the metadata held in the buffer, not shown, to the metadata filtering part 106, described later. As described above, metadata is held in the buffer, not shown, whereby metadata can be in turn supplied to the display part 111 without relying on the reception timing of metadata from the monitoring cameras 1a and 1b. Moreover, metadata can be supplied to the display part 111 in synchronization with video data. Furthermore, the metadata buffering part 103 stores metadata acquired from the monitoring cameras 1a and 1b in the metadata storage database 105. Here, in storing metadata in the metadata storage database 105, time information about video data synchronized with metadata is added. With this configuration, without reading the description of metadata to determine point in time, the added time information is used to read metadata at a desired point in time out of the metadata storage database 105.

The filter setting database 107 stores filter settings in accordance with the filtering process performed by the metadata filtering part 106, described later, as well as supplies the filter settings to the metadata filtering part 106. The term filter settings is settings that indicate determination criteria such as the necessities to output alarm information and to determine whether to switch the imaging operations of the monitoring camera 1a, 1b for every information about the monitoring target included in metadata. The filter settings are used to filter metadata to show the filtered result for every information about the monitoring target. The filtered result shows the necessities to output alarm information, to switch the imaging operations of the monitoring cameras 1a and 1b, and so on.

The metadata filtering part 106 uses the filter settings stored in the filter setting database 107 to filter metadata for determining whether to generate alarms. Then, the metadata filtering part 106 filters metadata acquired from the metadata buffering part 103 or metadata supplied from the metadata storage database 105, and notifies the filtered result to the rule switching part 108.

The vanishing point setting database 113 stores vanishing point setting information in the case in which the location at which the object can disappear out of the monitoring target area of the monitoring camera such as a door is set as the area having a vanishing point. The area having a vanishing point is indicated by a polygon, for example, based on its coordinate information, and a flag is added that indicates that it is the area having a vanishing point, and is set to the vanishing point setting information. Vanishing point setting information stored in the vanishing point setting database 113 is referenced in the filtering process done by the metadata filtering part 106, and analysis is made in accordance with vanishing point setting information. The details of the process in this case will be described later.

Based on the filtered result notified from the metadata filtering part 106, the rule switching part 108 generates the switching instruction signal, and notifies changes such as the switching of the imaging direction to the monitoring cameras 1a and 1b. For example, the rule switching part outputs the instruction of switching the operations of the monitoring cameras 1a and 1b based on the filtered result obtained from the metadata filtering part 106, so as to obtain monitor video suited for monitoring. Moreover, the rule switching part 108 supplies the recording request signal to the video data storage database 104 to store the video data acquired by the video buffering part 102 in the video data storage database 104 based on the filtered result.

The video data storage database 104 stores video data acquired by the video buffering part 102. The metadata storage database 105 stores metadata acquired by the metadata buffering part 103.

The video data processing part 109 performs the process that allows the display part 111 to display video data stored in the video data storage database 104. In other words, the video data processing part 109 in turn reads video data out of the reproduction position instructed by a user, and supplies the read video data to the display part 111. In addition, the video data processing part 109 supplies the reproduction position (a reproduction point in time) of video data being reproduced to the reproduction synchronizing part 112.

The reproduction synchronizing part 112 which synchronizes the reproduction of metadata with video data supplies a synchronization control signal to the metadata processing part 110, and controls the operation of the metadata processing part 110 so that the reproduction position supplied from the video data processing part 109 is synchronized with the reproduction position of metadata stored in the metadata storage database 105 by means of the metadata processing part 110.

The metadata processing part 110 performs the process that allows the display part 111 to display metadata stored in the metadata storage database 105. In other words, the metadata processing part 110 in turn reads metadata out of the reproduction position instructed by the user, and supplies the read metadata to the display part 111. In addition, as described above, in the case in which video data and metadata are reproduced, the metadata processing part 110 controls the reproduction operation based on the synchronization control signal supplied from the reproduction synchronizing part 112, and outputs metadata synchronized with video data to the display part 111.

The display part 111 displays live (raw) video data supplied from the video buffering part 102, reproduced video data supplied from the video data processing part 109, live metadata supplied from the metadata buffering part 103, or reproduced metadata supplied from the metadata processing part 110. In addition, based on the filter settings from the metadata filtering part 106, the display part 111 uses any one of monitor video, metadata video, and filter setting video, or uses video combining them, and displays (outputs) video showing the monitoring result based on the filtered result.

Moreover, the display part 111 also functions as a graphical user Interface (GUI). The user uses an operation key, a mouse, or a remote controller, not shown, and selects a filter setting menu displayed on the display part 111 to define the filter, or to display information about the analyzed result of individual processing parts and alarm information in GUI.

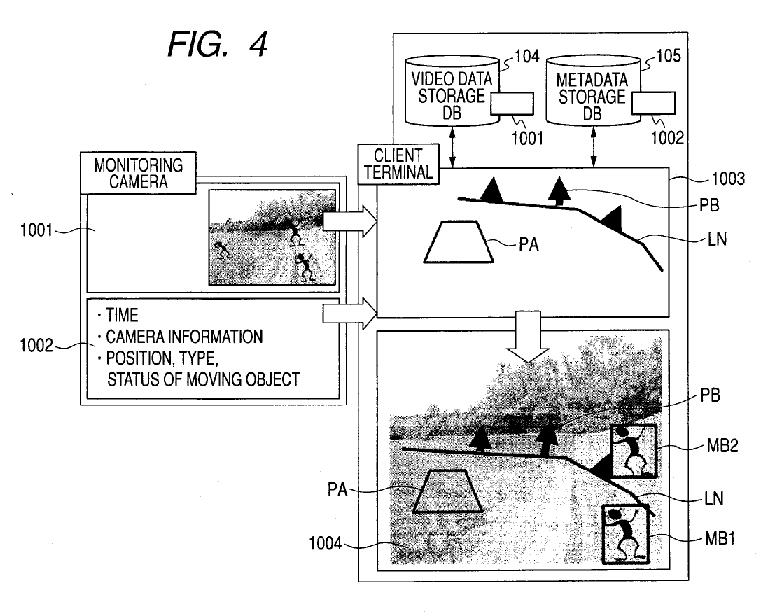

FIG. 4 shows an exemplary display of video data and metadata by the display part 111 of the client terminal 3 according to the embodiment. As shown in FIG. 4, video data 1001 and metadata 1002 imaged in the monitoring cameras 1a and 1b are supplied to the client terminal 3 via the network 2. For the type of metadata generated in the monitoring cameras 1a and 1b, there are points in time, object information about the analyzed result of video (for example, positions, types, status and so on), and the current state of the monitoring cameras. Moreover, this case is also effective in which the client terminal or the server is provided with a software module and the monitoring camera operates not via the network.

As discussed above, the client terminal 3 acquires, analyzes and stores the video data 1001 and the metadata 1002 supplied from the monitoring cameras 1a and 1b. The video data 1001 and the metadata 1002 inputted to the client terminal 3 are stored in the video data storage database 104, and the metadata storage database 105. The client terminal 3 has a filter setting function in which various filter settings are made through a filter setting screen (filter setting menu) displayed on the display part 111 and setting information is stored in the filter setting database 107.

On a filter setting display screen 1003 shown in FIG. 4, a line LN and an area PA are displayed that are generated by setting the filter. An arrow PB shows the passing direction that has to be detected with respect to the line LN.

Monitor video 1004 shows that the video data 1001 is superimposed on the filter, and they are displayed on the display part 111. The line LN is set as the passing filter. In the case in which objects passing through the filter are counted, the number of objects passing through the line LN is computed. On the screen, since objects MB1 and MB2 are detected as objects passing through the line LN, the number of objects is two.

However, because of disturbance such as noise on the system and abrupt changes in the brightness, and quick motion of an object (a moving object), it sometimes happens that the object that has been recognized as an object temporarily disappears and then again appears. In this case, in the case in which the object before disappearing and the object that again appears are recognized as different objects, the number of objects recognized as objects is twice as much as the actual number of objects. In order to prevent this event, such a setting is sometimes done that the object that has disappeared once and again appears at almost the same place is considered to be the same object.

However, for example, in the case in which that setting is applied to such a place that an object can actually disappear or appear such as an entrance, such an error can occur this time that even though there is another object, it is recognized as the same object.

In the embodiment, the place at which an object can actually disappear or again appear such as an entrance is defined as “an area having a vanishing point”. At the place which is set as the area having a vanishing point, such settings are made that an object that has once visually disappeared out of the monitoring screen and an object that has appeared at almost the same place are not considered to be the same object, whereby the number of objects obtained through the filter is approximated to the actual number of objects.

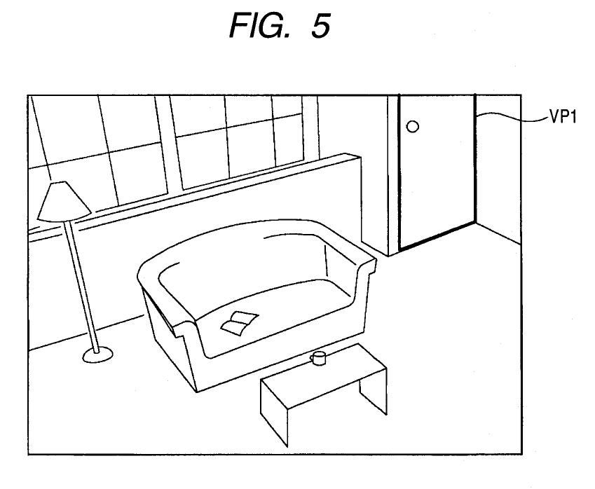

FIG. 5 shows an exemplary display in which a door on the monitoring screen is set to an area having a vanishing point VP. The setting that the door is set to the area having a vanishing point VP is stored in the vanishing point setting database 113 (see FIG. 3). The definitions and settings of the vanishing point may be made by the input from an operating part, not shown, based on user decision, or another system may be allowed to detect and define the vanishing point to use result information obtained from that system.

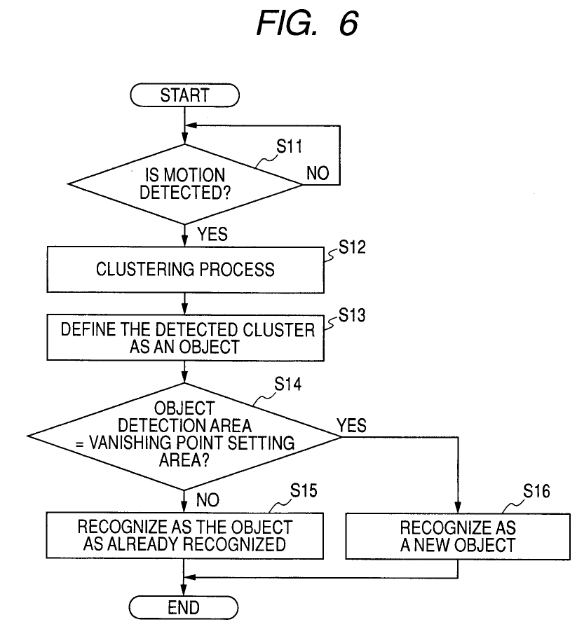

Next, the object recognition process according to the embodiment will be described with reference to a flow chart shown in FIG. 6. First, the monitoring camera 1 monitors whether there are pixels indicating the motion of an object of a monitoring target in units of macro blocks of 3×3 pixels, for example, and it is determined whether there is a moving object on the monitoring screen (Step S11). This process step continues until a moving object is detected. If a moving object is detected, clustering is performed that joins pixels indicating the motion of the object to each other (Step S12), and a joined cluster is defined as a single object (Step S13). So far, it is the process steps on the monitoring camera 1 side, and object information determined by the method described above is set as metadata to the client terminal 3.

The client terminal 3 receives metadata including object information, and determines whether the area in which the object is detected is the area in which the vanishing point is set (Step S14). If the area in which the object is detected is the area which is set as the area having a vanishing point, the object is recognized as a new object (Step S16). If the area in which the object is detected is the area which is not set as the area having a vanishing point, in the case in which it is confirmed that the object is an object that has disappeared at almost the same position right before the time at which the object has been detected, the object and the detected object are recognized as the same object (Step S15).

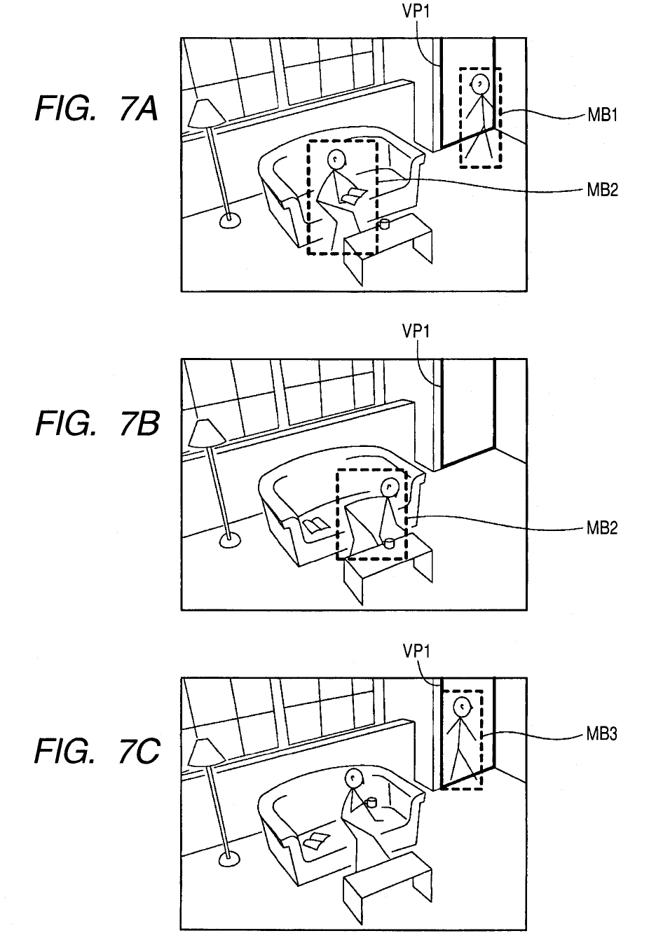

FIGS. 7A to 7C show a diagram depicting an exemplary display of an actual monitoring screen. FIGS. 7A to 7C show that an entrance on the upper right part of the screen is set as the area having a vanishing point VP. First, exemplary object recognition near the area having the vanishing point VP will be described. An object MB1 confirmed on the upper right part of the screen shown in FIG. 7A disappears out of the screen in FIG. 7B, and an object MB3 is recognized in FIG. 7C.

In this case, in the case in which this setting is made that “the object that has once disappeared and then appeared at almost the same place is considered to be the same object”, it is considered that the object MB1 in FIG. 7A and the object MB3 in FIG. 7C are the same object. In this state, when the number of objects is computed by a filter that counts the number of objects satisfying a predetermined condition, the numbers are counted as the object MB1=the object MB3=1.

However, suppose the objects MB1 and MB3 are actually different people, the number of objects obtained through the filter is smaller than the actual number of objects. On this account, in the embodiment, in the case in which an object has once disappeared and an object is again detected at almost the same place and the place is the area having a vanishing point VP, it is considered that the object before disappearing and the object after appearing again are different objects. When the similar definitions are applied to the other places, such a problem arises that the same object is overlapped and counted. Thus, it is defined that in the areas other than the area having a vanishing point VP, it is considered that the object that has once disappeared and again appeared at almost the same place is the same object.

Again returning to FIGS. 7A to 7C, now attention is focused on the object MB2 at the center on the screen for discussion. In FIG. 7A, suppose a person recognized as the object MB2 is not detected as a moving object because he/she is in the same attitude for a long time and it is considered that he/she has disappeared as an object. In this state, in the case in which the person moves again as shown in FIG. 7B, on the monitoring camera 1 side, such an event might happen that the object MB2 in FIG. 7A and the object MB2 in FIG. 7B are recognized to be different objects and different object IDs are assigned to them.

However, in the embodiment, in the case in which an object has disappeared and again appeared in the area other than the area that is set as the area having a vanishing point, it is considered that the object before disappearing and the object after appearing again are the same object. Therefore, it is considered that the object MB2 in FIG. 7A and the object MB2 in FIG. 7B are the same object, and it is counted as the object MB2=1, even though such a filter is used that counts the number of objects.

As described above, in the case in which the area in which an object can visually disappear and then appear at a place such as an entrance is set as the area having a vanishing point, an object once disappears and an object is again detected at almost the same place, the place is the area having a vanishing point, it is recognized that the object before disappearing are the object after appearing again different objects. Therefore, such an error is eliminated that various moving objects go in and out of an entrance and the objects are recognized as the same object, and errors between the number of actual objects (moving objects) and the number of objects obtained through the filter are made small.

Moreover, in the areas other than the area having a vanishing point, it is recognized that the object before disappearing and the object after appearing again are the same object. Therefore, the object before disappearing and the object after appearing again are recognized as the same object even in the case in which although an object does not actually disappear, it is recognized that the object has disappeared because of some factors such as disturbance. On this account, the number of objects obtained through a filter is made closer to the actual number of objects.

In addition, the embodiment described so far, the object ID is assigned on the monitoring camera side, but this task may be done on the client terminal side.

Moreover, a series of the process steps of the embodiment described above cant be executed by hardware, which may be executed by software. In the case in which a series of the process steps is executed by software, a program configuring the software is installed in a computer incorporated in a dedicated hardware, or a program configuring desired software is installed in a multi-purpose personal computer that can execute various functions by installing various programs.

Furthermore, in the embodiment described above, it is configured in which metadata outputted from the monitoring camera (the monitoring imaging device) is filtered. However, the target for the filtering process is not restricted to metadata, and the configuration can be adapted to various cases in which data in various forms is filtered. For example, this configuration may be performed in which video (the image) of video data outputted from the monitoring camera is directly analyzed in the client terminal.

It should be understood by those skilled in the art that various modifications, combinations, sub-combinations and alterations may occur depending on design requirements and other factors insofar as they are within the scope of the appended claims or the equivalents thereof.

What is claimed is:

1. A monitoring apparatus which uses video data imaged and outputted from a monitoring imaging device for monitoring, the apparatus comprising:
a filter setting part configured to store filter information for analyzing the video data;
a vanishing point setting part configured to store a place at which an object included in the video data can disappear out of an area for a monitoring target of the monitoring imaging device as an area having a vanishing point; and
a filtering part configured to use filter information stored in the filter setting part for analyzing the video data and to generate alarm information in accordance with the analyzed result,
wherein in the case in which it is recognized that an object has once disappeared in the area having the vanishing point and an object is again detected at almost the same place, the filtering part recognizes that two objects are different objects and analyzes the video data.

2. The monitoring apparatus according to claim 1, wherein the filtering part is a filter which filters metadata that is outputted by the monitoring imaging device together with video data and that indicates information about a monitoring target, under conditions set in the analyzing setting part.

3. The monitoring apparatus according to claim 1, wherein the alarm information includes the number of objects matched with the conditions of the filter or the accumulated number of the objects matched with the conditions of the filter.

4. The monitoring apparatus according to claim 1, wherein the area having the vanishing point is represented by a polygon.

5. The monitoring apparatus according to claim 4, wherein in the vanishing point setting part, area information represented by a polygon is associated with a flag indicating that the area is a vanishing point for storage.

6. The monitoring apparatus according to claim 4, wherein in the case in which the object is detected out of the area having the vanishing point and it is confirmed that another object has disappeared at a place near the place at which the object has been detected, right before a point in time at which the object has been detected, the filtering part recognizes that the detected object and the another object are the same object.

7. A monitoring system comprising:
a monitoring imaging device; and
a monitoring apparatus which uses video data imaged and outputted from the monitoring imaging device for monitoring, wherein the monitoring imaging device includes:
an imaging part configured to image a monitoring target and to output video data, and
the monitoring apparatus includes:
a filter setting part configured to store filter information for analyzing the video data;
a vanishing point setting part configured to store a place in which an object included in the video data can disappear out of an area for a monitoring target of the monitoring imaging device as an area having a vanishing point; and
a filtering part configured to use filter information stored in the filter setting part for analyzing the video data and to generate alarm information in accordance with the analyzed result,
wherein in the case in which it is recognized that an object has once disappeared in the area having the vanishing point and an object is again detected at almost the same place, the filtering part recognizes that two objects are different objects and analyzes the video data.

8. A monitoring method adapted to a monitoring system configured of a monitoring imaging device and a monitoring apparatus which uses video data imaged and outputted from the monitoring imaging device for monitoring, the method comprising the steps of:
in the monitoring imaging device, imaging a monitoring target and outputting video data,
in the monitoring apparatus, storing filter information for analyzing the video data;
storing a place in which an object included in the video data can disappear out of an area for a monitoring target of the monitoring imaging device as an area having a vanishing point;
using the filter information for analyzing the video data and generating alarm information in accordance with the analyzed result; and
in the case in which it is recognized that an object has once disappeared in the area having the vanishing point and an object is again detected at almost the same place, recognizing that two objects are different objects and analyzing the video data.

9. A monitoring program adapted to a monitoring system configured of a monitoring imaging device and a monitoring apparatus which uses video data imaged and outputted from the monitoring imaging device for monitoring, the program comprising the steps of:
in the monitoring imaging device, imaging a monitoring target and outputting video data,
in the monitoring apparatus, storing filter information for analyzing the video data;
storing a place in which an object included in the video data can disappear out of an area for a monitoring target of the monitoring imaging device as an area having a vanishing point;
using filter information for analyzing the video data and generating alarm information in accordance with the analyzed result; and
in the case in which it is recognized that an object has once disappeared in the area having the vanishing point and an object is again detected at almost the same place, recognizing that two objects are different objects and analyzing the video data.
